(19) United States
(12) Patent Application Publication
(10) Pub. No.: US 2025/0023312 A1
(43) Pub. Date: Jan. 16, 2025

(54) METHOD FOR PRODUCING AN ASSEMBLY OF A CONNECTOR AND COAXIAL CABLE, AND ASSEMBLY

(71) Applicant: Robert Karst GmbH & Co. KG, Berlin (DE)

(72) Inventor: Ronald Wolf, Berlin (DE)

(21) Appl. No.: 18/769,625

(22) Filed: Jul. 11, 2024

(30) Foreign Application Priority Data
Jul. 11, 2023 (DE) 102023118280.3

(51) Int. Cl. H01R 43/04; H01R 24/40; H01R 103/00

(52) U.S. Cl. CPC H01R 43/04; H01R 24/40; H01R 2103/00

(57) ABSTRACT

The invention relates to a method for producing an assembly made of a connector and a coaxial cable or a component for such an assembly including providing an outer conductor part, the outer conductor part having at least one connecting section having an inner wall; providing an inner conductor part and an insulation part; providing a coaxial cable; stripping an outer conductor section of the coaxial cable; everting the stripped outer conductor section around a first cable section of the coaxial cable and arranging the wires on the outside of the cable jacket in the first cable section; joining the coaxial cable with the outer conductor part to form the assembly or the component; and reducing the inside diameter of the connecting section. The invention also relates to an assembly.

### TECHNICAL FIELD

The invention relates to a method for producing an assembly of a connector and a coaxial cable, and to an assembly made of the connector and the coaxial cable. Furthermore, the use of the assembly for high-frequency applications is introduced.

A conventional assembly made of a connector and a coaxial cable usually comprises a support clamp or a support sleeve, which surrounds the outer conductor of the coaxial cable. The support clamp or support sleeve is used to implement high retaining forces. Depending on the design, it is also possible for a separate crimp clamp or an additional crimp tube to be present, which encloses the outer conductor part of the assembly. The described measures serve, in particular, the operational safety and the failure safety of the assembly. In general, the support clamp or the support sleeve or the crimp clamp or the crimp tube is situated at a connecting section of the outer conductor part. A crimp clamp or a crimp tube can, for example, be used to apply the necessary retaining forces according to FAKRA specifications. The outer conductor part can be a tube, for example, which is an integral part and represents a connection between the cable outer conductor and the outer conductor part of a complementary connector.

During experiments, it was found that high-frequency characteristics (for example the impedance curve and the reflection coefficient) are adversely affected by a support clamp or a support sleeve or a crimp clamp or a separate crimp tube. Excessive compression or shape changes of an insulator can also adversely affect the high-frequency characteristics.

It is therefore the object of the invention to provide a solution to this problem. In particular, it is thus the object of the invention to solve the conflict of objectives between high retaining forces and favorable high-frequency characteristics, that is, to offer a solution that satisfies both desired properties.

### BACKGROUND

According to the invention, in particular a method for producing an assembly made of a connector for high-frequency applications and a coaxial cable or a component for such an assembly is introduced, comprising: providing an outer conductor part, the outer conductor part comprising at least one connecting section having an inner wall, which is at least partly designed as a hollow cylinder; providing an inner conductor part and an insulation part; providing a coaxial cable, the coaxial cable comprising an outer conductor, which has wires, an inner conductor, which is at least partly arranged in the interior of the outer conductor, an insulator, which is at least partly arranged in the interior of the outer conductor and at least partly encloses the inner conductor, and a cable jacket, which at least partly encloses the outer conductor; stripping an outer conductor section of the coaxial cable; everting the stripped outer conductor section around a first cable section of the coaxial cable and arranging the wires on the outside of the cable jacket in the first cable section; joining the coaxial cable with the outer conductor part to form the assembly or the component, the outer conductor part being pushed with the connecting section of the outer conductor part over the first cable section; reducing the inside diameter of the connecting section, whereby/wherein the cable jacket is at least compressed in a first subregion of the connecting section and the wires bear against the inner wall of the connecting section and the cable jacket, wherein the first subregion comprises at least 70% of a region of the connecting section in which the wires between the inner wall and the cable jacket are arranged.

### BRIEF DESCRIPTION OF THE DRAWINGS

The invention will be described hereafter based on exemplary embodiments. In the drawings:

FIG. 1 shows a section of an assembly according to the invention;

FIG. 2 shows an enlargement of the section of FIG. 1;

FIG. 3 shows the male outer conductor part according to the invention from FIG. 1;

FIG. 4a shows the assembly according to the invention from FIG. 1 in a simplified exploded view;

FIG. 4b shows an assembly according to the invention including a female outer conductor part in a simplified exploded view;

FIG. 5 shows a schematic representation of the step of reducing the inside diameter of the connecting section;

FIG. 6 shows a schematic representation of a method according to the invention for producing an assembly according to the invention;

FIG. 7a shows an exemplary impedance curve in the time domain (comparison of assemblies according to the invention to a conventional assembly comprising a support sleeve); and

FIG. 7b shows an exemplary curve of a reflection coefficient in the frequency domain (comparison of assemblies according to the invention to a conventional assembly comprising a support sleeve).

Identical reference numerals used in various figures denote identical or substantially similar features, even if not all of the features shown with reference numerals are addressed in detail for each figure.

### DETAILED DESCRIPTION

Features are at times described in the singular hereafter. Such a description, alternatively or additionally, also encompasses a corresponding disclosure for multiple such features, if present. The expression “at least partly” has the same meaning as “entirely or partly.”

The “wires on the inner wall of the connecting section” and the “wires between the inner wall and the cable jacket” denote the wires of the everted outer conductor section or, in other words, the sections of the wires in the everted outer conductor section.

The information that the first subregion comprises at least 70% of the region of the connecting section in which the wires are arranged between the inner wall and the cable jacket shall be understood to mean that the inside diameter is reduced everywhere in the at least 70% of the described region (in other words: along the entire length of the at least 70% of the region), and the cable jacket is compressed everywhere in the at least 70% of the described region (in other words: along the entire length of the at least 70% of the region).

The wires are preferably clamped between the inner wall of the outer conductor part and the cable jacket where the wires bear against the inner wall of the connecting section and the cable jacket.

In the region of the connecting section in which the wires are arranged between the inner wall and the cable jacket, the wires are preferably clamped between the inner wall of the outer connector part and the cable jacket.

In the region of the connecting section, of which at least 70% is comprised by the first subregion and in which the wires are arranged between the inner wall and the cable jacket, the wires are preferably clamped between the inner wall of the outer connector part and the cable jacket.

In other words, the inside diameter of the connecting section is reduced in the first subregion. Reductions of the inside diameter of the connecting section do not necessarily have to take place evenly and/or uniformly and/or to the same degree. Reductions of the inside diameter of the connecting section, however, preferably take place evenly and/or uniformly and/or to the same degree in the first subregion.

The connecting section is designed everywhere, or at least in sections, as a hollow cylinder, at least in the first subregion. In particular in the region of the connecting section in which the wires are arranged between the inner wall and the cable jacket, the connecting section can be designed everywhere or at least in sections as a hollow cylinder. The reduction of the inside diameter can take place to the same degree at all points of the described region and/or of the first subregion. This can positively influence the high-frequency characteristics, with high retaining forces at the same time.

During assembly, further parts can be added so as to form the connector. The method can relate to the assembly of one component, which can be supplemented or assembled with further parts or components to form the assembly according to the invention. The method can be used to produce any assemblies according to the invention, which are structurally described hereafter.

Features of the introduced embodiments or method features described hereafter can be the subject matter of the method according to the invention. With respect to the method according to the invention, the embodiments of the assembly according to the invention are incorporated by reference in their entirety, and vice versa. The introduced method can be at least partly carried out in an automated manner.

Stripping the outer conductor section of the coaxial cable, in particular, includes removing the cable jacket at the corresponding section of the coaxial cable, which contains the outer conductor section prior to stripping. Everting describes moving the wires of the outer conductor section toward the coaxial cable (toward the cable jacket thereof) and can resemble the turning-up of an umbrella. Arranging the wires on the outside of the cable jacket in the first cable section can essentially take place simultaneously with the everting.

An optional arrangement of the wires along the longitudinal direction of the first cable section can take place simultaneously with the everting. Everting and/or arranging the wires (optionally an arrangement along the longitudinal direction) can, in particular, include a partial or complete dissolution of a braid of the stripped outer conductor section. The wires of the stripped outer conductor section can then, for example, only still form a wide-meshed braid or, preferably, no braid at all. This means that the wires only superimpose and intersect one another to a minor degree or not at all. A superposition or an intersecting is advantageously avoided to a particularly high degree when the wires are arranged along the longitudinal direction. This drastically reduces subsequent renewed superposition processes, caused by the assembly (pushing-over of the connecting region). This arrangement is therefore preferred. An advantageous consequence is that particularly high retaining forces can be implemented when few or no superpositions are present. In addition, a positive influence on the high-frequency characteristics exists due to the even compression of the cable jacket and the cable.

The outer conductor part and the insulation part can form a shared unit, for example in the form of a shared and/or joined and/or prefabricated part. The inner conductor part and the inner conductor of the coaxial cable can form a shared unit, for example in the form of a shared and/or joined and/or prefabricated part. It may be provided that at least two further parts of the assembly form at least one shared unit, for example in the form of a shared and/or joined and/or prefabricated part.

The connecting section can be pushed onto the first cable section under pressure.

The joining of the described parts to form the assembly can, in particular, include one or more or all of the following steps:
inserting the insulation part into the outer conductor part (unless the outer conductor part and the insulation part already form a shared part and/or are already joined; in this case, the described step can possibly be eliminated);
connecting the inner conductor part to the inner conductor of the coaxial cable (unless the inner conductor of the coaxial cable and the inner conductor part already form a shared part and/or are already joined; in this case, the described step can possibly be eliminated); and
connecting the outer conductor part to a housing of the assembly.

Generally speaking, the method can in particular comprise: joining the inner conductor part and the insulation part to the coaxial cable and the outer conductor part to form the assembly or the component, the outer conductor part being pushed with the connecting section of the outer conductor part over the first cable section.

The inside diameter of the connecting section is advantageously reduced when the first cable section is already situated in the connecting section. The reduction of the inside diameter can be carried out by pressure that is applied from the outside on all sides onto the connecting section, for example by means of two half shells, as will be described hereafter. Other methods of applying pressure are also possible, for example by changing the ambient pressure in the region of the connecting section. The inside diameter of the connecting section can be reduced in a subregion of the connecting section (wherein at least 70% of the region of the connecting section in which the wires are arranged between the inner wall and the cable jacket is comprised) or in relation to the overall connecting section.

The introduced method represents a simple, cost-effective, rapid and automatable option for producing the assembly according to the invention including all its advantages (see below). The reduction of the inside diameter of the connecting section, including at least 70% of the region of the connecting section in which the wires are arranged between the inner wall and the cable jacket, represents an effective option for increasing the retaining forces while preserving the high-frequency characteristics. It is particularly advantageous in the process that no excessive compression of the cable (and of the insulator) arises when the inside diameter is reduced over such a long region (this is advantageous for the high-frequency characteristics), and high retaining forces are nonetheless possible.

In one advantageous specific embodiment of the method according to the invention, the connecting section is entirely designed as a hollow cylinder.

This can in particular mean that no cuts, interruptions, omissions or spacings are provided in an outer contour of the connecting section. In particular, no cuts, interruptions, omissions or spacings can be provided at an outer end of the connecting section.

The described specific embodiment of the method according to the invention represents a simple option for increasing the retaining forces while preserving the high-frequency characteristics. A continuous hollow cylinder can apply particularly even forces on the cable and thereby enable high retaining forces at compressions of the cable which are not excessive. Moreover, the manufacturing complexity of the outer conductor part and the manufacturing complexity for producing the assembly according to the invention are low.

In one advantageous specific embodiment of the method according to the invention, the first subregion completely comprises the region of the connecting section in which the wires are arranged between the inner wall and the cable jacket.

The inside diameter can be reduced wherever folded-over wires are arranged. The reduction of the inside diameter can take place to the same degree at all points of the first subregion.

The introduced specific embodiment represents another effective option for increasing the retaining forces while preserving the high-frequency characteristics.

In one advantageous specific embodiment of the method according to the invention, the reduction of the inside diameter of the connecting section is carried out with the aid of two half shells, which each have a semi-cylindrical recess, wherein the two half shells are pressed with the semi-cylindrical recesses onto the connecting section, wherein the inside radius of the semi-cylindrical recesses is smaller than the outside diameter of the connecting section before the inside diameter is reduced.

In particular, the inside radius of the semi-cylindrical recesses can be smaller, preferably slightly smaller, than the outside diameter of the connecting section before the inside diameter is reduced, for example preferably by at least 2%, and particularly preferably by at least 4%. An expedient upper limit can particularly preferably be 7% or 10%, even more preferably 5%. An interval between 4% and 5% has proven to be particularly advantageous. Further expedient intervals are: 2 to 5%, 2 to 7%, 2 to 10%, 4 to 7%, 4 to 10%. An inner radius of the semi-cylindrical recesses which is too small would result in non-even deformation of the connecting section and in the formation of burrs.

The introduced specific embodiment enables a simple and easily automatable implementation of the advantages according to the invention. In particular, the embodiment represents a simple method for practically applying pressure on all sides.

In one advantageous specific embodiment of the method according to the invention, the inside diameter of the connecting section is reduced by at least 4%.

In this way, a considerable increase in the retaining forces between the connector and the coaxial cable is advantageously already effectuated by such an inside diameter reduction.

In one advantageous specific embodiment of the method according to the invention, the inside diameter of the connecting section is reduced by no more than 5% or by no more than 10% or by no more than 15%. These limits can be combined with the above-described lower limit of at least 4%.

In this way, it can advantageously be achieved particularly reliably that the diameter reduction takes place non-evenly and/or with the formation of burrs, including when component tolerances and tool tolerances are taken into consideration.

In one specific embodiment of the method according to the invention, everting the stripped outer conductor section around the first cable section of the cable jacket and arranging the wires of the stripped outer conductor section along the longitudinal direction of the first cable section are carried out by brushing-back, in particular by means of a wire brush.

In practical experiments, the use of a wire brush has proven to be a simple, rapid and cost-effective as well as easily automatable option for implementing the steps of everting and arranging the wires along the longitudinal direction in one joint step. In particular, a rotating wire brush can be used.

In one advantageous specific embodiment of the method according to the invention, the method also comprises: introducing at least one inwardly directed depression into the connecting section, the depression having a smaller axial extension than the first subregion.

In one specific embodiment, the at least one depression is introduced into the first subregion of the connecting section in at least which the inside diameter of the connecting section is reduced.

In one specific embodiment, the at least one depression is introduced into the region of the connecting section in which the wires are arranged between the inner wall and the cable jacket.

The introduction can be carried out, for example, by means of a punch or a crimping tool or another tool. The above-described advantages of a depression or a plurality of depressions can be implemented easily, quickly, cost-effectively, and in an easily automatable manner.

In one advantageous specific embodiment of the method according to the invention, the insulator of the coaxial cable is compressed by the introduction of the at least one depression.

In this regard, reference is made in particular to the further comments. The additional compression of the insulator advantageously results in an increase in the retaining forces.

In one advantageous specific embodiment of the method according to the invention, the assembly does not comprise an additional support clamp or support sleeve or crimp clamp or crimp tube arranged around the first cable section and/or around the insulator.

Reference is made to the advantages and remarks of the corresponding configuration of the assembly according to the invention. In particular, the high-frequency characteristics can be further enhanced, and the method can be simplified, in that a corresponding connecting step (for example crimping or attaching) is not necessary.

In one advantageous specific embodiment of the method according to the invention, the outer conductor part is configured as a tube, in particular as a thin-walled tube.

The outer conductor part is preferably made of metal.

The outer conductor part is preferably one piece.

The outer conductor part is preferably configured as a tube along the entire length thereof. The outer conductor part preferably does not contain any material accumulation (in particular on the outside) that goes beyond the configuration as a thin-walled tube. In particular, the outer conductor part preferably does not contain any material accumulation (in particular on the outside) that goes beyond 0.5 mm or, particularly preferably 0.3 mm, or still more preferably 0.1 mm, in terms of the wall thickness.

Major material accumulation or further material accumulation, in particular on an outer side of the tube, can be avoided. This may refer to material accumulation that may be present at any point of the outer conductor part. This may, alternatively or additionally, refer to material accumulation that may be integral with the tube (that is, in the form of a shared part).

The introduced specific embodiment is also advantageous with respect to the high-frequency characteristics and additionally has a particularly simple design and production process. The high-frequency characteristics are favorably influenced when no major material accumulation is present on the outside of the outer conductor part. A tube is easier to handle than parts having a more complex geometry, in particular with respect to automated embodiments of the method.

In one advantageous specific embodiment of the method according to the invention, the outer conductor part has a one-piece design.

An outer conductor part, in the form of a tube, does not need to have the same diameter throughout, but the diameter can also be constant.

A wall thickness of the outer conductor part can be 0.20 mm, for example. In particular, a wall thickness can be 0.03 to 1 mm, 0.03 to 0.5 mm, or 0.1 to 0.5 mm, preferably 0.1 to 0.3 mm, and particularly preferably 0.15 to 0.25 mm.

In one advantageous specific embodiment, the connecting section has a length in the range of 5 to 15 mm, preferably 7 to 10 mm, after the reduction of the inside diameter.

In one advantageous specific embodiment, the connecting section has a wall thickness in the range of 0.1 to 0.5 mm, preferably 0.1 to 0.3 mm, and particularly preferably 0.15 to 0.25 mm after the reduction of the inside diameter.

In one advantageous specific embodiment, the connecting section has an inside diameter in the range of 3.0 to 4.0 mm after the reduction of the inside diameter. The inside diameter does not need to be constant over the entire length of the connecting section.

The described specific embodiments are advantageous with respect to a good compromise between favorable high-frequency characteristics and high retaining forces. The high-frequency characteristics are favorably influenced when no major material accumulation is present on the outside of the outer conductor part, or when no major geometrical differences are present in the longitudinal direction of the outer conductor part, and the outer conductor part is also not too long (but nonetheless long enough to implement good retaining forces). A tube is easier to handle than parts having a more complex geometry, in particular with respect to automated embodiments of the method.

In one advantageous specific embodiment of the method according to the invention, the method additionally comprises: arranging the wires along a longitudinal direction of the first cable section.

Reference is made to the remaining remarks and advantages for this specific embodiment.

In one advantageous specific embodiment of the method according to the invention, a diameter reduction of the coaxial cable is present due to the compression of the cable jacket in the first cable section, wherein the diameter reduction is at least 4%, preferably 4% to 15%, compared to the second cable section. Additional values are stated hereafter during the disclosure of a product.

Reference is made to the remaining remarks and advantages for this specific embodiment. According to the invention, furthermore a product in the form of an assembly is introduced, which can in particular be obtained by way of the method according to the invention: An assembly made of a connector, in particular for high-frequency applications, and a coaxial cable, the connector comprising: an outer conductor part; an inner conductor part, which is at least partly arranged in the interior of the outer conductor part; and an insulation part, which is at least partly arranged in the interior of the outer conductor part and at least partly encloses the inner conductor part, the outer conductor part comprising at least one connecting section having an inner wall, the connecting section being at least partly designed as a hollow cylinder; the coaxial cable comprising: an outer conductor, which has wires; an inner conductor, which is at least partly arranged in the interior of the outer conductor; an insulator, which is at least partly arranged in the interior of the outer conductor and at least partly encloses the inner conductor; and a cable jacket, which at least partly encloses the outer conductor, the coaxial cable comprising a first cable section, which is arranged within the connecting section, the coaxial cable comprising a second cable section, which is arranged outside the connecting section, a stripped outer conductor section of the coaxial cable being arranged in the first cable section on the outside around and bearing against the cable jacket, the wires of the stripped outer conductor section being situated between the cable jacket and the outer conductor part of the connector and bearing against the inner wall of the connecting section and the cable jacket, and at least the cable jacket being compressed by the outer conductor part, at least in a first subregion of the connecting section.

The first subregion comprises at least 70% of a region of the connecting section in which the wires are arranged between the inner wall and the cable jacket.

The assembly made of the connector and the coaxial cable can be used, in particular, for the purposes of data transmission. The assembly can, for example, be employed in the field of vehicle technology.

The assembly can have features, individually or in any combination, which were already described based on a method according to the invention. The assembly can be obtained by way of a method according to the invention.

The connector can, in particular, comprise a housing made of electrically insulating material. The outer conductor part can be at least partly situated within the housing. The connector can be a straight connector. As an alternative, the connector can be an angled connector which, in particular, has an angle of 90° between the coaxial cable and a plug-in-side connection. The connector can be a male connector, also referred to as a “plug,” or alternatively a female connector, also referred to as a “jack.”

The outer conductor part can, in particular, be configured as a tube. On the plug-in side located opposite the connecting section, the outer conductor part can in particular comprises a connection for a complementary connector or be connected to such a connector. The outer conductor part can be electrically and/or mechanically connected to the outer conductor part of a complementary connector. The outer conductor part and the insulation part can form a shared unit, for example in the form of a shared and/or joined and/or prefabricated part.

The outer conductor part is electrically and physically connected to the outer conductor of the coaxial cable. The inner conductor part is at least electrically connected to the inner conductor of the coaxial cable. There may also be a direct physical connection between the inner conductor part and the inner conductor, for example with the aid of a crimp connection. The inner conductor part and the inner conductor of the coaxial cable can form a shared unit, for example in the form of a shared and/or joined and/or prefabricated part. It may be provided that at least two further parts of the assembly form at least one shared unit, for example in the form of a shared and/or joined and/or prefabricated part.

The connecting section can be entirely or partly designed as a hollow cylinder. The connecting section is used to receive the coaxial cable through the connector. When the outer conductor part is partly or completely designed as a tube, the connecting section can be part of this tube. The connecting section can be a section of the outer conductor part which surrounds and/or makes contact with the coaxial cable, including the outer conductor of the coaxial cable (regardless of whether or not the outer conductor is stripped), or can comprise this section. The connecting section can be the complete section of the outer conductor part which surrounds and/or makes contact with the coaxial cable, including the outer conductor (regardless of whether or not the outer conductor is stripped), or can comprise this section. The connecting section can partly or completely comprise the region of the coaxial cable in which the wires of the stripped outer conductor section are situated.

The connecting section can have at least one depression, which will also be addressed in a specific embodiment described hereafter. The depression has a smaller axial extension that the first subregion. A depression can, for example, be a corrugation in the transverse direction to the connecting section or a corrugation in the longitudinal direction to the connecting section. A corrugation may, in particular, be understood to mean a line-shaped or edge-like impression (in the radial direction to the inside). A depression can, alternatively, be a peripheral groove or a crimp or a peripheral crimp. Multiple depressions can be provided at the connecting section. For example, a depression can be provided at a first end region of the connecting section and a further depression can be provided at a second end region of the connecting section located opposite the first end region. Depressions can also be present radially opposite one another at the connecting section. Depressions are used to increase the retaining forces of the coaxial cable in the connecting section.

The outer conductor has wires, for example in the form of a braid. The outer conductor can at least partly be a braid. In other words, the outer conductor can be at least in part composed of chords, leads, strands and/or fibers. It may be provided that the outer conductor comprises chords, leads, strands and/or fibers that do not form a braid or only in part form a braid. A shielding foil can optionally be present beneath the outer conductor or as part of the outer conductor.

Wires are preferably arranged in the first subregion.

The first cable section is situated within the connecting section. It can, for example, have been inserted into the connecting section or be pushed in under pressure. There is a diameter reduction, preferably of a hollow cylinder. This is carried out, in particular, after the first cable section has been inserted into the connecting section during the production process. As a result of the outer conductor part, which here is the inner wall of the connecting section, and the wires of the stripped outer conductor section being pressed onto the cable jacket, the compression of the cable jacket can be effectuated. In addition, a compression of the insulator of the coaxial cable can thus be achieved. A compression of the cable jacket or of the insulator can, in particular, mean that pressure is exerted by the connecting section on the cable jacket or the insulator. The pressure from the connecting section on the cable jacket can act directly, proceeding from the inner wall of the connecting section, or indirectly, proceeding from the inner wall of the connecting section via the stripped outer conductor section. The pressure from the connecting section on the insulator can take place indirectly, proceeding from the inner wall of the connecting section, possibly via the stripped outer conductor section, via the cable jacket and the outer conductor contained in the coaxial cable, and possibly a shielding foil. A compression of the cable jacket or of the insulator can also mean that a volume reduction and/or a diameter reduction of the relevant part (cable jacket and/or insulator) exists compared to the second cable section. The second cable section is located outside the connecting section and may, in particular, be in a state under ambient conditions, that is, not be compressed, apart from the customary ambient pressure. A compression of the cable jacket or of the insulator can also mean that pressure is exerted thereon which exceeds the ambient pressure.

By compressing the insulator of the coaxial cable, retaining forces can be further increased since a compression of the insulator can automatically effectuate a change in shape of the cable jacket in interaction with the connecting section. Excessive compression of the insulator, however, can adversely affect the high-frequency characteristics. For this reason, a diameter reduction of the insulator should be no more than 25% or 20%, preferably no more than 15%, and particularly preferably no more than 10% or no more than 8% or no more than 5%, in each case compared to the uncompressed state, such as is present in the second cable section.

Optionally or additionally, at least one depression can be present in the connecting section, the depression having a smaller axial extension than the first subregion. In particular, the depression can have been introduced after the first cable section has been inserted in the connecting section during the production process and after the inside diameter of the connecting section has been reduced, for example by pushing in or by crimping the connecting section.

As a result of the outer conductor part (the inner wall of the connecting section), and the wires of the stripped outer conductor section being pressed onto the cable jacket at the at least one depression, additional compression of the cable jacket can possibly be effectuated. In addition, a compression of the insulator of the coaxial cable can thus be achieved and/or amplified. In this way, retaining forces of the assembly (between the connector and the coaxial cable) can be increased.

The second cable section is a conventional part of the coaxial cable under ambient conditions. The first cable section (in the state before it is situated in the connecting section) can correspond to the second cable section in terms of the design and dimension. Both cable sections can, in particular, be part of the same coaxial cable and have an identical design. The two cable sections can abut one another.

The stripped outer conductor section can be a turned-over and/or folded-over and/or everted and/or brushed-back region of the outer conductor of the coaxial cable. This can mean that, before the turning-over and/or folding-over and/or everting and/or brushing-back, the cable jacket can have been removed around the stripped outer conductor section so that the stripped outer conductor section was initially exposed. The stripped outer conductor section can then have been changed in terms of the position thereof so as to be situated around the cable jacket, for example by turning over, folding over, everting and/or brushing back. In practice, brushing-back by means of a wire brush has proven useful.

The connecting section or at least a subregion of the connecting section is situated around the stripped outer conductor section. The connecting section can, in particular, push the wires of the stripped outer conductor section onto the cable jacket, in particular where the inside diameter is being reduced, that is, in particular in the first subregion. This may result in partial shape changes of the cable jacket. For example, furrow-like indentations can arise in the cable jacket, which can be elastic and/or plastic deformations. In this way, the desired high retaining forces between the coaxial cable and the connector can be implemented.

The wires of the stripped outer conductor section can be arranged along the longitudinal direction of the first cable section. “Along” may mean that minor deviations from the longitudinal direction, for example deviations by no more than 5 to 10 or 15 or 20 or 25 degrees, are permissible. The deviations are preferably smaller than 20 degrees, and preferably smaller than 10 degrees. Such an arrangement in the longitudinal direction can, in particular, be achieved as part of the turning-over and/or the folding-over and/or the everting and/or the brushing-back. An arrangement of the wires in the longitudinal direction has proven to be positive in experiments with respect to the high-frequency characteristics and the retaining forces.

The cable jacket and optionally the insulator can be made of deformable material. This can mean that these can, in particular, be made of an elastically and/or plastically deformable plastic material. The cable jacket and optionally the insulator can thus be easily compressible, in particular compared to the inner conductor, which is typically made of metal.

So as to implement the compression of the cable jacket and optionally of the insulator, the inside diameter of the connecting section can, in particular, be smaller than the outside diameter of the second cable section, or smaller than the sum of the outside diameter of the second cable section and one time the thickness or twice the thickness of one of the wires of the outer conductor. A reduction of the inside diameter of the connecting section can, in particular, have been implemented by pressure being applied from the outside on all sides, or almost all sides, on the connecting section, as is described in other passages. Reference is likewise made to the comments regarding depressions, which can be designed as corrugations, for example. With the aid of a depression (for example a peripheral groove or a peripheral crimp), a (possibly further) reduction of the inside diameter of the connecting section can be achieved.

A depression can, in particular, be a crimp or a cu or an at least partly peripheral depression or an at least partial peripheral groove. A depression can be longitudinally or transversely oriented. The connecting section can correspond to the region of the outer conductor part in which the stripped outer conductor section is arranged. The connecting section can be larger, or in particular longer, than the described region. For example, the connecting section can comprise a further region in which no wires are present between the inner wall of the outer conductor part and the cable jacket.

The first subregion of the connecting section in which the cable jacket and optionally the insulator are compressed by the outer conductor part (by the inner wall of the connecting section) can be a region of the connecting section in which one depression or multiple depressions are provided. For example, one depression or multiple depressions can be provided as follows: [0097] a single depression in the region of the connecting section in which the stripped outer conductor section is arranged and/or two radially opposing depressions in the described region; and/or multiple depressions in the region of the connecting section in which the stripped outer conductor section is arranged; and/or multiple pairs of two radially opposing depressions in the described region.

As an alternative or in addition, the following can be provided in any combination: a single depression in a region of the connecting section in which the stripped outer conductor section is not arranged; and/or two radially opposing depressions in the region of the connecting section in which the stripped outer conductor section is not arranged; and/or multiple depressions in the region of the connecting section in which the stripped outer conductor section is not arranged; and/or multiple pairs of two radially opposing depressions in the region of the connecting section in which the stripped outer conductor section is not arranged.

In particular, an assembly according to the invention is disclosed, wherein a plurality of depressions in the form of two first depressions and two second depressions are provided, wherein the two first depressions are located radially opposite one another and the two second depressions are located radially opposite one another, wherein the two first depressions and the two second depressions are provided at different longitudinal sections of the connecting section. The different longitudinal sections can be longitudinally opposing end sections of the connecting section, that is, for example, the respective first and last 15% of the connecting section, viewed from a side.

The first subregion of the connecting section in which the cable jacket and optionally the insulator are compressed by the outer conductor part (by the inner wall of the connecting section) and the wires of the stripped outer conductor section (since the inside diameter is compressed according to the invention) can comprise almost the entire region, and preferably the entire region, of the connecting section in which the wires are arranged between the inner wall of the outer conductor part and the cable jacket, for example at least 70, 80 or 90% of this region.

The described compression is implemented by the reduction of the inside diameter and optionally additionally one or more depressions. The compression of the cable jacket and optionally of the insulator can preferably also be implemented in the entire region of the connecting section in which the wires are arranged between the inner wall of the outer conductor part and the cable jacket, implemented by a reduction of the inside diameter and optionally additionally one or more depressions. The reduction of the inside diameter and depressions together can effectuate a compression of the cable jacket and optionally of the insulator.

In addition, the cable jacket and optionally the insulator can be compressed in a further subregion of the connecting section in which no wires of the stripped outer conductor section are present. A compression then only takes place by the inner wall of the connecting section. The first subregion of the connecting section in which the cable jacket and optionally the insulator are compressed by the inner wall of the connecting section can also be almost the entire connecting section, for example at least 70, 80 or 90% of the connecting section, implemented by a reduction of the inside diameter and optionally one or more depressions. The compression of the cable jacket and optionally of the insulator can, alternatively, also be implemented in the entire connecting section, implemented by a reduction of the inside diameter and optionally one or more depressions. A reduction of the inside diameter and depressions together can effectuate a compression of the cable jacket and optionally of the insulator.

In particular, an assembly according to the invention is disclosed, wherein the cable jacket and optionally the insulator are compressed on a length of at least 70% or at least 80% or at least 90% of the connecting section by the inner wall of the connecting section and due to the inside diameter of the hollow cylinder.

The wires of the stripped outer conductor section can be arranged so as to not intersect, or only intersect to a minor degree, within the stripped outer conductor section. For example, the wires can be arranged in such a way that no more than 30% or no more than 20% or preferably no more than 10% or, particularly preferably no more than 5%, of the wires intersect. “Intersect” can, in other words, also be understood to mean “superimpose” or “overlap.”

In practical experiments, it has been shown that it is possible to implement high retaining forces at likewise good high-frequency characteristics with the aid of a compression by the outer conductor part (the inner wall of the connecting section) and the wires of the stripped outer conductor section. Herein lies an essential advantage of the invention. A force-fit connection between the coaxial cable and the connector is established, wherein a form-locked component is also present due to a reduction of the inside diameter of the connecting section. If additionally a depression is present in the connecting section, a force-fit and, even more pronounced, form-locked connection that has particularly high retaining forces can be established between the coaxial cable and the connector. Moreover, the assembly can be produced inexpensively and in a technologically simple manner, even in an automated manner.

In one advantageous specific embodiment, the insulator of the coaxial cable is additionally compressed by the outer conductor part, at least in a second subregion of the connecting section. A reduction of the inside diameter of the connecting section likewise takes place in the second subregion, if present. In the second subregion, the reduction of the inside diameter can be smaller than, equal to, or greater than in the first subregion.

Such a compression can, in particular, be achieved by the reduction of the inside diameter of the connecting section and/or by one depression or multiple depressions.

A depression is present in the connecting section, preferably in an aforementioned second subregion.

It is possible for multiple second subregions to be present.

It is possible for multiple depressions to be present.

A depression can be located in a second subregion.

If the insulator, optionally, is already compressed in the aforementioned first subregion, the insulator is preferably more strongly compressed in the second subregion than in the first subregion. Percentage values for the compression are stated elsewhere in this description and can correspondingly differ in the first and second subregions. If the second subregion overlaps with the first subregion or the second subregion is located within the first subregion, the compression values, which hereafter are stated as percentages, shall not be additively considered, but indicated minimum values, maximum values or ranges apply. Example: When a range of 4 to 10% is indicated (see ranges indicated below) and the second subregion is located within the first subregion, the insulator is compressed in total at least 4% and no more than 10% in the second subregion. In the first region where the first subregion does not overlap with the second subregion, the insulator can, for example, be compressed by 4%, and in the second subregion, it can be compressed in total 4% to no more than 10%, in particular 5 to 10%. However, instead, the insulator may not be compressed in the first subregion where the first subregion does not overlap with the second subregion, and may only be compressed in total 4 to 10% in the second subregion.

A compression of the insulator (note; and also of the cable jacket, reference is made in this regard to the further comments) can, in particular, mean that pressure is exerted by the connecting section on the insulator. The pressure from the connecting section on the insulator can take place indirectly, proceeding from the inner wall of the connecting section, possibly via the stripped outer conductor section, via the cable jacket and the outer conductor contained in the coaxial cable, and possibly a shielding foil. A compression of the insulator can also mean that a volume reduction and/or a diameter reduction of the insulator exists compared to the second cable section. The second cable section is located outside the connecting section and may, in particular, be in a state under ambient conditions, that is, not be compressed, apart from the customary ambient pressure. A compression of the insulator can also mean that pressure is exerted thereon which exceeds the ambient pressure.

The second subregion can be located within the first subregion or overlap therewith.

Multiple second subregions can be present. The first subregion and at least one of the second subregions can completely or partly overlap with one another. Most preferably, the at least one second subregion is located within the first subregion. At least one depression (for example designed as a corrugation, a peripheral groove, a crimp and/or a peripheral crimp) can be situated in the at least one second subregion. If multiple second subregions are present, at least one depression may be present within each of the multiple second subregions (for example designed as a corrugation, a peripheral groove, a crimp and/or a peripheral crimp).

The introduced specific embodiment allows retaining forces to be advantageously increased. If a maximum diameter reduction of the insulator of no more than 25% is adhered to, the high-frequency characteristics are not worsened or only insignificantly worsened.

In an advantageous embodiment, the first subregion is larger than the second subregion and the insulator is only compressed in the second subregion.

When the second subregion is preferably smaller than the first subregion, the high-frequency characteristics, which can be adversely affected by excessive compression, or also by excessive compression of the insulator that is also carried out over too large a surface area, are only insignificantly worsened. Nevertheless, the retaining forces can advantageously be increased to a high degree. The second subregion can be the region of the connecting section in which no stripped outer conductor section is present. The second subregion can also be a subregion of the connecting section in which no stripped outer conductor is present.

In one advantageous specific embodiment, at least one inwardly directed depression is provided at the inner wall of the connecting section, wherein the insulator is preferably compressed by the at least one depression.

With the aid of a depression, the compression of the cable jacket can be initially caused or amplified. The inside diameter can already be reduced at the point at which the depression is provided, in particular in any case when the point is situated in the first subregion. As an alternative or in addition, the insulator can be compressed by the depression. Reference is made to the further comments regarding the compression of the insulator and of the cable jacket.

Depressions may be present at one point or multiple points. Depressions can be located radially opposite one another at the connecting section so that symmetry in the cross-section and/or in the longitudinal section is achieved. A depression can be corrugation, a crimp or a groove, for example. In particular, reference is made to the further comments regarding depressions. The at least one depression can be located in the second subregion.

With the aid of one depression or a plurality of depressions, particularly high retaining forces can be achieved between the coaxial cable and the connector. When the insulator is compressed by the depression, the retaining force can advantageously be further increased since greater form fit can be present. In particular, a small and comparatively flat depression, however, does not simultaneously result in strong compression of the insulator so that the high-frequency characteristics are not adversely affected, or only insignificantly adversely affected.

In one advantageous specific embodiment, the insulator, in a longitudinal section of the coaxial cable, is compressed in the outside diameter thereof by no more than 25% or by no more than 20% or by no more than 15% or by no more than 10% or by no more than 5% compared to the outside diameter of the insulator in the second cable section.

In this way, it is particularly advantageously avoided that the high-frequency characteristics are adversely affected by excessive compression of the insulator.

In one advantageous specific embodiment, a diameter reduction of the coaxial cable is present due to the compression of the cable jacket in the first cable section, wherein the diameter reduction is at least 4%, preferably at least 5% or at least 10% or at least 15%, compared to the second cable section.

The diameter reduction is present over at least 70% of the region of the connecting section in which the wires are arranged between the inner wall and the cable jacket. The diameter reduction can additionally be present in the region of the connecting section in which no wires of the stripped outer conductor section are arranged.

A diameter reduction of at least 4%, preferably at least 10%, particularly preferably at least 15%, enables desirable retaining forces between the coaxial cable and the connector. The diameter reduction is preferably no more than 20%, particularly preferably no more than 25% or no more than 30%.

The aforementioned minimum diameter reductions and maximum diameter reductions can be arbitrarily combined to form ranges. Desirable intervals are thus: 4 to 10%, 4 to 15%, 4 to 20%, 4 to 25%, 4 to 30%, 10 to 15%, 10 to 20%, 10 to 25%, 10 to 30%, 15 to 20%, 15 to 25% or 15 to 30%. An excessive diameter reduction adversely affects the high-frequency characteristics, in particular since excessive compression of the insulator is present.

In one specific embodiment, a (possibly further) diameter reduction of the coaxial cable is present, with a depression at the inner wall of the connecting section.

The depression can, in particular, be arranged in the region of the connecting section at which wires of the stripped outer conductor section are situated between the cable jacket and the outer conductor part of the connector. Another depression which is located radially opposite the depression may be provided. A compression in the form of a diameter reduction of the coaxial cable can also already be present due to the inner wall of the connecting section and the wires. The diameter reduction (and therefore a compression) due to the depression can be in addition to that. The depression can, for example, be a peripheral groove or a peripheral crimp.

The specific embodiment is advantageous since it represents an easy-to-produce and effective means for increasing the retaining forces between the coaxial cable and the connector.

In one advantageous specific embodiment, a maximum diameter reduction of the insulator of the coaxial cable due to compression in the first cable section is no more than 25% compared to the second cable section.

A greater diameter reduction of the insulator adversely affects the high-frequency characteristics, in particular since excessive compression of the insulator is present. At a diameter reduction of the insulator of no more than 25% compared to the second cable section which corresponds to the uncompressed state, the high-frequency characteristics are decreased to a degree which is still reasonable. Nonetheless, a (possibly additional) diameter reduction of the insulator enables desirable retaining forces between the coaxial cable and the connector.

Desirable intervals for the maximum diameter reduction of the insulator are 4 to 10%, 4 to 15%, 4 to 20%, 4 to 25%, 10 to 15%, 10 to 20%, 10 to 25%, 15 to 20%, or 15 to 25%.

In one advantageous specific embodiment, the cable jacket is at least compressed over a length of 80% of the connecting section.

This length can, in particular, include a region of the connecting section in which no wires of the stripped outer conductor section, but only the cable jacket is in contact with the connecting section. “80%” can likewise refer to the first cable section. The cable jacket can also be compressed in the entire connecting section. A compression can, in particular, be effectuated by a diameter reduction of the inner wall of the connecting section, and optionally by at least one depression in the inner wall of the connecting section. As even a deformation of the insulator as possible, which can be achieved in this specific embodiment, is advantageous in particular for the high-frequency characteristics. A compression in a comparatively long region moreover enables high retaining forces. So as to increase the retaining forces, additionally at least one depression can be provided.

In one advantageous specific embodiment, the assembly does not comprise an additional support clamp or support sleeve or crimp clamp or crimp tube arranged around the first cable section.

The support clamp or support sleeve or crimp clamp or the additional crimp tube can be any part that is at least partly arranged around the first cable section, that is, surrounds the first cable section. In particular, the support clamp or support sleeve can be a metallic part. In particular, the support clamp or support sleeve can be part of a crimp connection. The support clamp or support sleeve or crimp clamp or the additional crimp tube is not the outer conductor part.

Omitting the described parts improves the high-frequency characteristics of the assembly, as was already addressed. The assembly according to the invention nonetheless advantageously implements a high retaining force, with good high-frequency characteristics, in particular since increased compressive stress is present at the outer conductor part due to the compression of the cable jacket.

In another aspect, the invention relates to the use of the assembly according to the invention, as described above in general and specific embodiments for the transmission of high frequency (signals), as a high-frequency connector, in a high-frequency connector or for the production of a high-frequency connector.

In still another aspect, the invention relates to a high-frequency connector comprising the assembly according to the invention.

The term ‘high frequency’ shall be understood to mean a frequency of at least 1 kHz (kilohertz), preferably at least 10 kHz, more preferably at least 50 kHz, still more preferably at least 100 kHz, or at least 1000 kHz, and most preferably at least 10 MHz. 20 GHz (gigahertz) is preferred as the upper frequency limit, which can be combined with all of the described lower limits. High frequency thus means 1 kHz to 20 GHz, preferably 10 kHz to 20 GHz, 50 kHz to 20 GHz, 100 kHz to 20 GHz, 1000 kHz to 20 GHz, 10 MHz to 20 GHz.

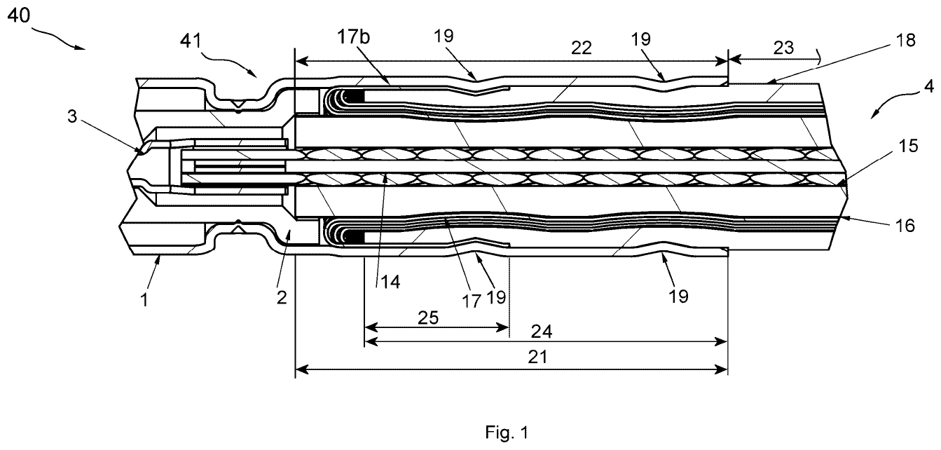

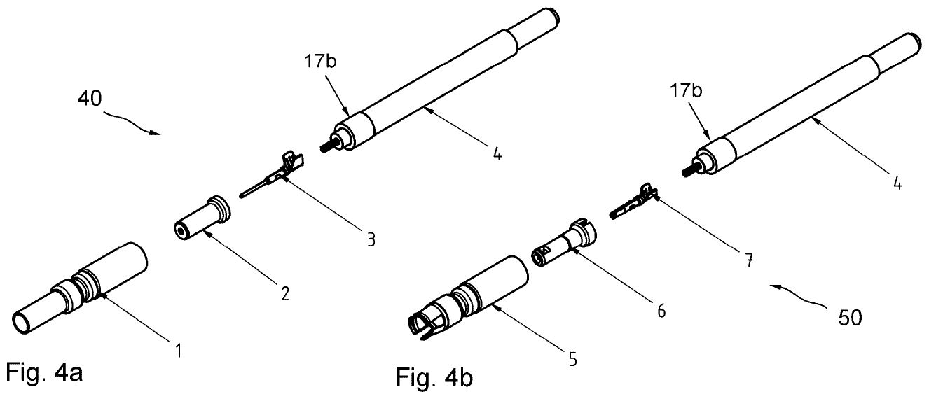

FIG. 1 shows a section of an assembly 40 according to the invention in a longitudinal sectional view. The assembly 40 comprises a connector 41 and a coaxial cable 4. The connector 41 comprises an outer conductor part 1, an insulation part 2, and a male inner conductor part 3. As an alternative, the female inner conductor part 7 (FIG. 4b) or, generally speaking, an inner conductor part could be installed instead of the male inner conductor part 3. The male inner conductor part 3 is partly situated within the insulation part 2. The coaxial cable 4 comprises a cable jacket 18, a braid-like outer conductor 17 including wires, a shielding foil 16, an insulator 15, and an inner conductor 14. The shielding foil 16 shall be understood as an optional part in this exemplary embodiment and does not necessarily have to be present.

The outer conductor part 1 has four depressions 19, which are situated in a connecting section 21. Two of the depressions 19 (on the left in FIG. 1) are located radially opposite one another and are situated in a region 25 of the connecting section 21 in which the wires are arranged between an inner wall of the connecting section 21 and the cable jacket 18. In other words, a stripped outer conductor section 17b is peripherally arranged between the cable jacket 18 and the outer conductor part 1 in this region 25. The two other depressions 19 are likewise situated in the connecting section 21, but in a region in which no stripped outer conductor section 17b is arranged. They are likewise located radially opposite one another. The depressions are designed as corrugations, and each have edge-like extensions in the transverse direction to the plane of FIG. 1.

The coaxial cable 4 comprises a first cable section 22, which is situated in the connecting section 21. The cable moreover comprises a second cable section 23 which, directly adjoining the first cable section 22, is situated outside the connecting section 21.

The stripped outer conductor section 17b is composed of wires. These stem from a cable region on the left in FIG. 1, before the first cable section 22 in the direction of the plug-in-side cable end. The cable jacket 18 and the insulator 15 are partly removed here. The stripped outer conductor section 17b is folded over and is present in the form of individual wires, which do not intersect and are not located on top of one another, but are present individually along the longitudinal direction of the first cable section 22 (which here corresponds to the longitudinal direction of the connecting section 21).

The inside diameter of the connecting section 21 is slightly smaller than the diameter of the cable jacket 18 in the uncompressed state. This means that the cable jacket 18 is not discernibly compressed in the entire length of the connecting section 21 (see in particular the end of the connecting section 21 on the right side of FIG. 1). The region in which the cable jacket 18 is compressed is a first subregion 24.

The insulator 15 can also optionally be compressed in the entire length of the connecting section 21 (not shown).

The inside diameter of the connecting section 21 can, for example, be reduced from 3.97 mm to 3.78 mm (can correspond to the inside diameter of the connecting section 21 without depressions 19) when an RTK031 coaxial cable is to be used as the coaxial cable 4. Alternatively, the inside diameter of the connecting section 21 can, for example, be reduced from 4.17 mm to 3.78 mm (can correspond to the inside diameter of the connecting section 21 without depressions 19) when an RTK044 coaxial cable is to be used as the coaxial cable 4.

The inner conductor 14 of the coaxial cable 4 is electrically and mechanically connected to the inner conductor part 3 of the connector 41 by means of a crimp. The outer conductor 17, in the form of the stripped outer conductor section 17b, is connected in a force-fit manner, by way of pressure, to the connecting section 21 of the outer conductor part 1. A form-locked component is likewise present since the inside diameter of the connecting section 21 is reduced. Due to the left depressions 19, additionally a further, more pronounced form fit component is present.

Due to the depressions 19, the cable jacket 18 is further compressed in each case in the nearby regions. The insulator 15 is likewise compressed in the nearby regions, as is apparent from FIG. 1. Here, pronounced form fit is present between the coaxial cable and the outer conductor part. Due to this design, high retaining forces are implemented, at good high-frequency characteristics of the assembly 40 according to the invention.

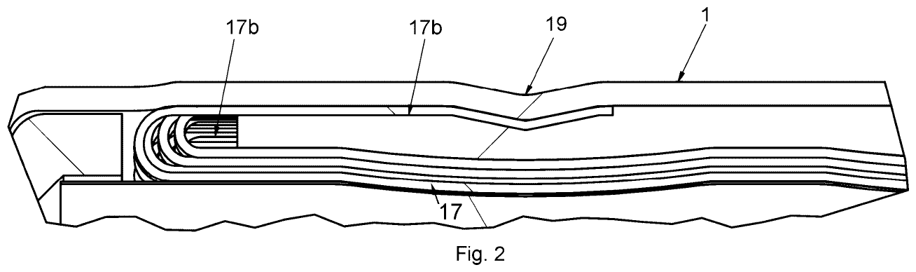

FIG. 2 shows an upper region of the connecting section 21 and of the first cable section 22 in an enlarged view. It is apparent that the outer conductor 17 within the coaxial cable 4 has multiple layers. The outer conductor 17 is designed as a braid. The braid is shown in a simplified manner in FIG. 2 (and also in FIG. 1) in the form of wires that are arranged on top of one another. The stripped outer conductor section 17b is, as intended, shown as a simple wire. Wires are present circumferentially next to one another.

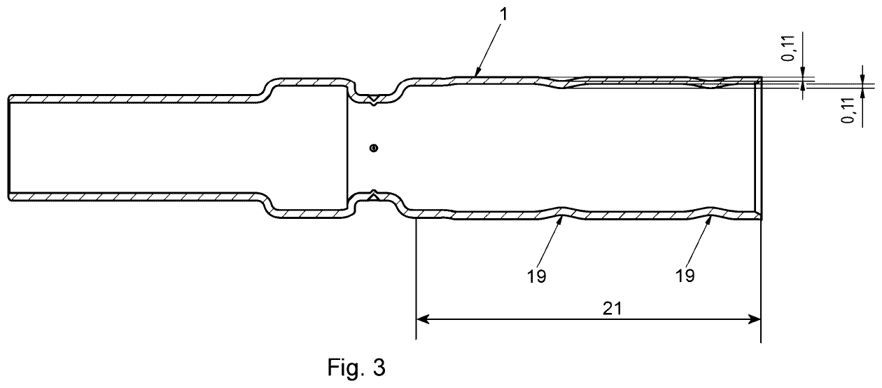

FIG. 3 shows the outer conductor part 1 separately. In the shown exemplary embodiment of the assembly 40 according to the invention, each of the depressions 19 has a depth of 0.11 mm (for the sake of simplicity, the reference numerals at the upper depressions 19 are not shown). This numerical value is an example. The outside diameter of the connecting section 21 is 3.78 mm, for example. The inside diameter is 3.38 mm, for example. The diameter of the coaxial cable 4 is 3.5 mm, for example. Together with the stripped outer conductor section 17b, the diameter of the coaxial cable 4 is 3.85 mm, for example. This means that, based on these exemplary values, a compression of the cable jacket 18 is present over the entire connecting section 21, even though it is minor in the region of the connecting section 21 in which no wires of the stripped outer conductor section 17b are present.

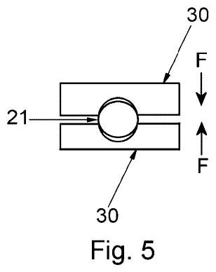

The inside diameter of connecting section 21 was reduced during the production process after the first cable section 22 was introduced (numerical examples: see above). Prior to that, the inside diameter was 3.57 mm, for example, and the outside diameter was 3.97 mm, for example. The reduction of the two diameters of the connecting section 21 was carried out, for example, (in practice) by the application of pressure on all sides with the aid of two half shells 30 (see FIG. 5), which each have a semi-cylindrical recess.

The stripped outer conductor section 17b was turned over onto the cable jacket 18, for example, by utilizing a rotating wire brush.

FIG. 4a shows a simplified exploded view of the components of the assembly 40 according to the invention, which was already shown in FIGS. 1 to 3. The inner conductor part 3 is connected to the inner conductor 14 by means of crimps. This is an assembly including a male connector 41. FIG. 4b shows a corresponding assembly 50 including a female connector (jack) in a simplified exploded view. The outer conductor part 5, in particular, has a different design including spring-like segments at the plug-in-side end for receiving a complementary male connector. An insulation part 6 is differently configured than the insulation part 2, and a female inner conductor part 7 is likewise differently configured than the male inner conductor part 3. The design of the assembly 50 is similar to the design of the assembly 40.

FIG. 5 shows a schematic representation of the step of reducing the inside diameter of the connecting section 21. Two half shells 30, which each have a semi-cylindrical recess, push with a force F on the connecting section 21. Since the two semi-cylindrical recesses have an inside diameter that is only slightly smaller than the (not yet reduced) outside diameter of the connecting section 21, the outside diameter and thus also the inside diameter of the connecting section are reduced, while maintaining the round cross-section (hollow cylindrical shape). In this way, the connecting section 21 can be easily elongated, since the material must yield.

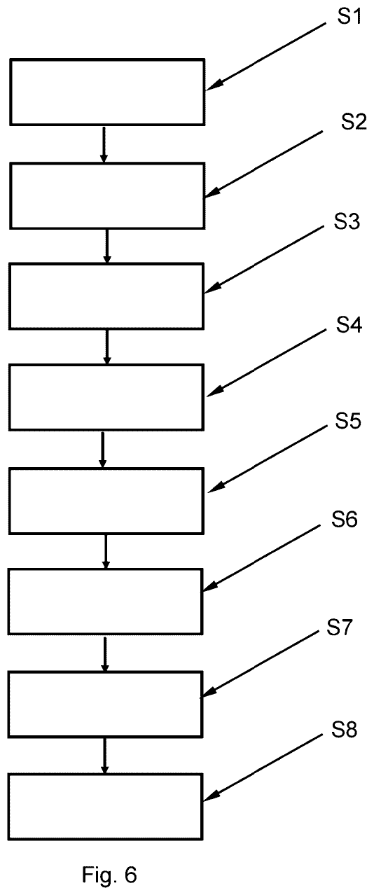

FIG. 6 schematically shows the method according to the invention for producing an assembly according to the invention.

In a first step S1, an outer conductor part 1 (see FIG. 1) including a connecting section 21 (see FIG. 1) is provided. Likewise, an inner conductor part 3 (see FIG. 1), an insulation part 2 (see FIG. 1) and a coaxial cable 4 (see FIG. 1) are provided. The coaxial cable 4, from the outside to the inside, comprises a cable jacket 18 (see FIG. 1), a braid-like outer conductor 17 (see FIG. 1) including wires, a shielding foil 16 (see FIG. 1), an insulator 15 (see FIG. 1), and an inner conductor 14 (see FIG. 1).

In a second step S3, an outer conductor section 17b (see FIG. 1) is stripped at a cable end. This means that the cable jacket 18 is removed at this cable end.

In a third step S3, the stripped outer conductor section 17b is everted around the coaxial cable 4. The stripped outer conductor section 17b is moreover everted and brushed back onto the cable jacket 18 of the coaxial cable 4 with the aid of a wire brush. The braid of the stripped outer conductor section 17b is undone so that the individual wires are no longer connected to one another by superposition and intersection. The individual wires are everted in the longitudinal direction of the coaxial cable 4 during the course of the brushing-back process.

In a fourth step S4, a section of the inner conductor 14 of the coaxial cable 4 is stripped in the cable region from the stripped outer conductor section 17b stems. The inner connector 14 is connected to the inner conductor part 3 by means of crimping.

The insulation part 2 is now pushed with the through-opening thereof onto the inner conductor part 3 in a fifth step S5.

In a sixth step S6, the outer conductor part 1 is pushed with pressure, with the connecting section 21 thereof, past the insulation part 2, onto a first cable section 22. The stripped outer conductor 17b is now clamped between the cable jacket 18 and the inner wall of the connecting section 21.

In a seventh step S7, the inside diameter of the connecting section 21 is reduced, wherein the reduction of the inside diameter of the connecting section is carried out with the aid of two half shells 30, which each have a semi-cylindrical recess, wherein the two half shells 30 are pressed from the outside with the semi-cylindrical recesses onto the connecting section 21, and wherein the inside radius of the semi-cylindrical recesses is smaller than the outside diameter of the connecting section 21 before the inside diameter is reduced.

In an eighth step, two radially opposing depressions 19 are impressed in each case in the connecting region 21 with the aid of a corresponding tool at the front and rear end regions of the connecting region 21. The depressions 19 (see FIG. 1) are transverse corrugations. While the cable jacket 18 is compressed in the entire connecting region 21, the insulator 15 is only compressed in the regions of the first cable section 22 in which the depressions 19 are situated.

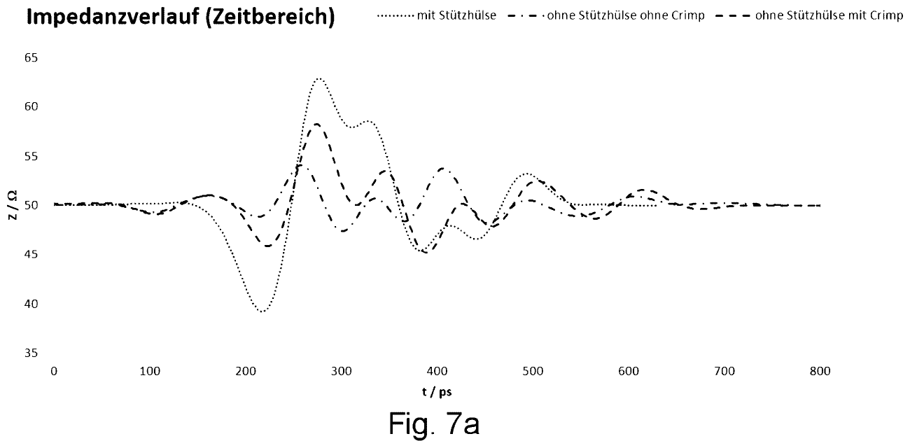

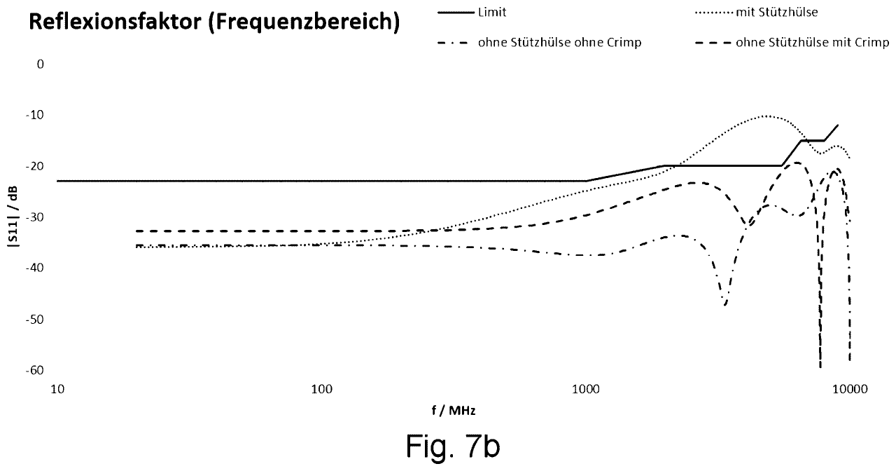

FIG. 7a shows impedance curves (ohm) in the time domain over the time in ps. The first, dotted line shows the impedance curve for an assembly (coaxial cable and connector) including a support sleeve. An unfavorable minimum forms at approximately 200 ps and, following the same, unfavorable maxima form. The second, dotted line shows an impedance curve for an assembly according to the invention without support sleeve with a crimp (depression at the outer conductor). The extrema are already significantly reduced. This is advantageous. The third, dash-dotted line without support sleeve and without crimp shows another, even more advantageous reduction.

FIG. 7b shows the reflection coefficient (dB) in the frequency domain (MHz). The solid delimiting line shows an expedient limit that should not be exceeded. The first, dotted line shows the progression of the reflection coefficient for an assembly (coaxial cable and connector) including a support sleeve. The limit is exceeded at higher frequencies. The second, dotted line shows the progression of the reflection coefficient for an assembly according to the invention without support sleeve with a crimp (depression at the outer conductor). The limit is not exceeded.

This is already advantageous. The third, dash-dotted line without support sleeve and without crimp shows another, even more advantageous reduction to significantly below the limit.

### LIST OF REFERENCE SIGNS

1: outer conductor part
14: inner conductor
15: insulator
16: shielding foil
17: outer conductor
17b: stripped outer conductor section
18: cable jacket
19: depression
2: insulation part
21: connecting section
22: first cable section
23: second cable section
24: first subregion
25: region of the connecting section in which the wires are arranged between the inner
wall and the cable jacket
3: inner conductor part
30: half shell
4: coaxial cable
40: assembly according to the invention (male)
41: connector
5: outer conductor part
50: assembly according to the invention (female)
6: insulation part
7: inner conductor part (female)
S1-S8: method steps
F: force

What is claimed is:

1. A method for producing an assembly made of a connector for high-frequency applications and a coaxial cable or a component for such an assembly, comprising:
providing an outer conductor part, the outer conductor part comprising at least one connecting section having an inner wall, which is at least partly designed as a hollow cylinder;
providing an inner conductor part and an insulation part;
providing a coaxial cable, the coaxial cable comprising an outer conductor, which has wires, an inner conductor, which is at least partly arranged in the interior of the outer conductor, an insulator, which is at least partly arranged in the interior of the outer conductor and at least partly encloses the inner conductor, and a cable jacket, which at least partly encloses the outer conductor;
stripping an outer conductor section of the coaxial cable;
everting the stripped outer conductor section around a first cable section of the coaxial cable and arranging the wires on the outside of the cable jacket in the first cable section;
joining the coaxial cable with the outer conductor part to form the assembly or the component, the outer conductor part being pushed with the connecting section of the outer conductor part over the first cable section; and
reducing the inside diameter of the connecting section, whereby the cable jacket is compressed at least in a first subregion of the connecting section and the wires bear against the inner wall of the connecting section and the cable jacket,
the first subregion comprising at least 70% of a region of the connecting section in which the wires are arranged between the inner wall and the cable jacket.

2. The method according to claim 1, wherein the connecting section is designed completely as a hollow cylinder.

3. The method according to claim 1, wherein the first subregion completely comprises the region of the connecting section in which the wires are arranged between the inner wall and the cable jacket.

4. The method according to claim 1, wherein the reduction of the inside diameter of the connecting section is carried out with the aid of two half shells, which each have a semi-cylindrical recess, the two half shells being pressed with the semi-cylindrical recesses onto the connecting section, and the inside radius of the semi-cylindrical recesses being smaller than the outside diameter of the connecting section before the inside diameter is reduced.

5. The method according to claim 1, wherein the inside diameter of the connecting section is reduced by no more than 5%.

6. The method according to claim 1, further comprising:
introducing at least one inwardly directed depression into the connecting section, the depression having a smaller axial extension than the first subregion.

7. The method according to claim 6, wherein the at least one depression is introduced into the first subregion of the connecting section.

8. The method according to claim 6, wherein the at least one depression is introduced into the region of the connecting section in which the wires are arranged between the inner wall and the cable jacket.

9. The method according to claim 6, wherein the insulator of the coaxial cable is compressed by the introduction of the at least one depression.

10. The method according to claim 1, wherein the assembly does not comprise an additional support clamp or support sleeve or crimp clamp or crimp tube arranged around the first cable section and/or the insulator.

11. The method according to claim 1, wherein the outer conductor part is configured as a tube.

12. The method according to claim 1, wherein a diameter reduction of the coaxial cable is present due to the compression of the cable jacket in the first cable section, the diameter reduction being at least 4%, preferably 4% to 15%, compared to the second cable section.

13. The method according to claim 1, wherein the connecting section has one or more of the following features after the reduction of the inside diameter:
a length in the range of 5 to 15 mm;
a wall thickness in the range of 0.1 to 0.5 mm;
an inside diameter in the range of 3.0 to 4.0 mm.

14. An assembly made of a connector, in particular for high-frequency applications, and a coaxial cable, produced by way of the method according to claim 1,
the connector comprising:
an outer conductor part;
an inner conductor part, which is at least partly arranged in the interior of the outer conductor part; and
an insulation part, which is at least partly arranged in the interior of the outer conductor part and at least partly encloses the inner conductor part,
the outer conductor part comprising at least one connecting section having an inner wall, the connecting section being at least partly designed as a hollow cylinder;
the coaxial cable comprising:
an outer conductor, which has wires;
an inner conductor, which is at least partly arranged in the interior of the outer conductor;
an insulator, which is at least partly arranged in the interior of the outer conductor and at least partly encloses the inner conductor; and
a cable jacket, which at least partly encloses the outer conductor,
the coaxial cable comprising a first cable section, which is arranged within the connecting section,
the coaxial cable comprising a second cable section, which is arranged outside the connecting section,
a stripped outer conductor section of the coaxial cable being arranged in the first cable section so as to surround and bear against the outside of the cable jacket,
the wires of the stripped outer conductor section being located between the cable jacket and the outer conductor part of the connector and bearing against the inner wall of the connecting section and the cable jacket, and
at least the cable jacket being compressed by the outer conductor part, at least in a first subregion of the connecting section.

15. The assembly according to claim 14, configured for the transmission of high frequency or high-frequency signals, as a high-frequency connector, in a high-frequency connector or for the production of a high-frequency connector.
